(19) United States
(12) Patent Application Publication
(10) Pub. No.: US 2004/0218633 A1
(43) Pub. Date: Nov. 4, 2004

(54) Method for multiplexing, in MPEG stream processor, packets of several input MPEG streams into one output transport stream with simultaneous correction of time stamps

(75) Inventor: Kamil Burzynski, Zielona Gora (PL)

Correspondence Address: WILLIAM COLLARD, COLLARD & ROE, P.C., 1077 NORTHERN BOULEVARD, ROSLYN, NY, 11576, US

(73) Assignee: Advanced Digital Broadcast Polsk Sp. z o.o.

(21) Appl. No.: 10/823,029

(22) Filed: Apr. 13, 2004

(30) Foreign Application Priority Data
Apr. 14, 2003 (PL) P359676

(51) Int. Cl. H04J 3/24

(52) U.S. Cl. 370/474

(57) ABSTRACT

According to the invention, input MPEG data packets are delivered to appropriate stream buffers from asynchronous program sources. The MPEG data packets have different transmission speeds with defined time stamps of their packets, while the packets of input MPEG streams are multiplexed and have their time stamps corrected in such a way that their assigned time stamps are deleted and replaced by values of time markers calculated according to the algorithm detecting and correcting the detected synchronization errors, after which the packets with so corrected time stamps are appended appropriately to the output MPEG stream. The essence of the invention is based in that packets of each input MPEG stream are transferred from stream buffers to appropriate packet buffers together with information about the time ratios between the neighboring packets of a given MPEG input stream. After that, input packets of MPEG streams are retrieved from the mentioned packet buffers by means of a multiplexer to the packet converter. In the packet converter there is a check of the time ratios between the neighboring packets of input streams, the state of the clock of a given output stream, the time of sending the last packet from the given packet buffer and the allowed time offset of packets in the output stream and on their basis the time markers, included in them, are corrected according to the value of the clock of MPEG output stream. Next, selected packets are appended adequately to the MPEG output stream.

### CROSS-REFERENCE TO RELATED APPLICATIONS

This application claims priority to Polish Application No. P-359676, filed Apr. 14, 2003, the contents of which are incorporated herein by reference.

### BACKGROUND OF THE INVENTION

1. Field of the Invention

The present invention relates to a method for multiplexing, in MPEG stream processor, packets of several input MPEG streams into one output transport stream with simultaneous correction of time stamps.

2. Brief Description of the Background of the Invention Including Prior Art

One output transport stream TS (Transport Stream) can include a few television channels. The ISO/IEC 1318-1 standard, defines three time stamps included in an MPEG stream (Motion Picture Experts Group). These time stamps are:

PCR (Program Clock Reference), which defines the expected time of receiving data and is included in the stream in equal time intervals for a given packets group, defining a specific program. PCR marker is broadcasted in the packet header, for example once every thousand of packets;

PTS (Presentation Time Stamp), which refers to synchronization between the elementary streams, abbreviated as ES;

DTS (Decoding Time Stamp), which defines the decoding time.

In the known state of the art, MPEG input stream packets are multiplexed and their time stamps are corrected in such a way that their set time markers are deleted and replaced with the time stamps values, calculated according to the algorithm detecting and correcting the detected synchronization errors. Next, the packets with thus corrected time stamps are appended appropriately to the output MPEG stream.

There is a device, known from the U.S. Pat. No. 5,790,543 and a method, used to detect the dis-synchronization, created during the transport of digitally scrambled information, such as packets of data scrambled in MPEG system, and to correct the values of time stamps, according to the detected synchronization errors. The disclosed system reads pairs of values of PCR time markers in the coded TS stream, while each pair of values of PCR time markers presents the expected time of receiving a stream segment, which corresponds to it. The real time of receiving for a stream segment, corresponding to it, is defined in response to detecting the corresponding values of PCR time stamps and a signal of an independent clock. The expected time of receiving the stream segment is compared to the real reception time in order to define dis-synchronization in the data packet stream. Synchronization errors are corrected by a combination of techniques of adaptive buffering and a change of PCR time stamps values and correcting values concurrent with the real time of receiving stream segments. The disclosed solution can be implemented in a reception system or as a part of a network node, which minimizes the effects of changeability of cells delay in ATM network. The described solution allows performing operation of dividing into segments, detecting and correcting their dis-synchronization and joining, performed for only one MPEG stream. Moreover it does not provide a possibility of deleting and/or adding data to the stream.

There is a method, known from a European patent application EP1175109, for measuring the PCR jitter, frequency offset and drift rate measurements with the use of a constant measurement bandwidth over non-uniform PCR arrival times and a variable PCR rate, which includes the following steps:

measurement of interval between the times of receiving PCR by means of a reference oscillator with asynchronous precision;

defining a constant band of measurements independently from the frequency of PCR changes, while the defined constant bandwidth of measurement differentiates between the jitter and wander frequencies;

calculating PCR jitter, frequency offset and changes of clock frequency as a function of interval between the times of PCR reception, PCR values for each time of PCR reception and a defined constant measuring band in the form of a series of difference equations.

The aforementioned series of difference equations derives from hybrid digital-analogue PLL model (Phase Locked Loop) of phase synchronization loop, where dis-synchronization, frequency offset and changes of clock frequency are extracted from various points of PLL feedback control system. More precisely, the series of difference equations is derived from approximation of linear filtering for the least mean square (LMS) of the average frequency offset and estimator of the LMS of the averages of clock frequency changes of a simple, second degree time equation for PCR value. The solution, from the EP application, illustrates the method of conducting error measurements of PCR clocks in a single stream. Moreover, it is required in this application that the PCR are correct with the tolerance, defined by ISO/IEC 13818-1 standard, thus more serious errors cannot be corrected in it.

There is a transmitter, known from U.S. patent application US2003007518. It includes a multilayer multiplexer, used to generate the output stream with assigned transmission speed, multiplexed from elementary streams with assigned transmission speeds. In this transmitter the multilayer multiplexer consists of at least the first master multiplexer and the next slave multiplexer. The master multiplexer receives the first elementary stream from the first input and the multiplexed stream from the second input, to which the stream from the slave multiplexer is given from at least the second elementary stream. The master multiplexer includes means for controlling the output transmission speed in order to guarantee defined average data speed as a function of data of elementary streams. This solution describes how from many elementary streams, abbreviated as ES, one transport stream, abbreviated as TS, can be composed, without correction of PCR time marker, because the input stream is created here from the very beginning.

There is a system of transferring multiplexed MPEG data, known from U.S. Pat. No. 5,905,732. The system accepts data from a plurality of sources and supplies them, on a packet basis, to a common data stream. The non-uniform jitter experienced by the packets is defined by subtracting the average delay for packets in a program from the current packet delay. Packets including PCR markers have their time base deleted, corrected with the calculated non-uniform time delay and placed as a PCR time base of the packet, which is supplied to the common data stream. Only the packets with PCR time values are modified.

There is a multiplexer of MPEG transport streams known from U.S. Pat. No. 6,002,687. This solution discloses the method of broadcasting many programs. Each program includes one or many elementary streams, which are scrambled in relation to one common time base, corresponding to a specific program. The broadcasted programs come from many input transport streams, every one of which includes many transport packets. Each transport packet includes identifier of the packet, defining the data, which it contains. Within every transport stream, unique packet identifiers are assigned to every elementary stream of each program. Data of each elementary stream are included only in transport packets, which have appropriate packet identifier. Every input transport stream includes time stamps for reconstructing the time base of a single program, which corresponds to every program transferred in the stream. The multiplexer contains a module of data linking, which receives many input transport streams. Data linking module also selectively removes the transported packets from the received input transport streams. The multiplexer contains a forward bus, after which the data linking module selectively sends at least a part of data from transport streams. The multiplexer selects, which packets, deleted from transport streams, are to be sent by the downstream bus, depending on the identifiers of packets from transport packets. Moreover, the multiplexer contains also a driver, which links the transport packets sent by downstream bus into a single output transport stream. In this solution all streams must have a common clock.

The above-presented solutions, define how to perform operation on MPEG clocks by means of hardware, together with defining models performing these actions of integrated circuits. Hardware-based solutions are characterized by many deficiencies such as more difficult upgrading, lesser flexibility, lower precision of clocks, limited number of audio-video channels from every input TS transport stream. Therefore the above-mentioned solutions are quite expensive and complex in configuration. Moreover, they do not allow adding randomly chosen data to MPEG streams.

### SUMMARY OF THE INVENTION

### PURPOSES OF THE INVENTION

It is an object of this invention to provide a method for audio/video streams multiplexing.

It is another object of this invention to provide a method of controlling flow of data between in the multiplexing system and a method for modifying the stream and adding new packets to the output stream.

These and other objects and advantages of the present invention will become apparent from the detailed description, which follows.

### BRIEF DESCRIPTIONS OF THE INVENTION

The invention provides a method of joining a few input MPEG streams into one output transport stream, in MPEG stream processing unit, with concurrent correction of time stamps. In this method input streams of MPEG data packets, with different transmission speeds, and with set time stamps of their packets, are delivered to appropriate stream buffers from many asynchronous software sources.

In the method of joining packets of a few input MPEG streams into one output stream in the unit processing MPEG transport streams with concurrent correction of time markers, according to the invention, input MPEG a packets are delivered to appropriate stream buffers from asynchronous program sources. The MPEG data packets have different transmission speeds with defined time stamps of their packets, while the packets of input MPEG streams are multiplexed and have their time stamps corrected in such a way that their assigned time stamps are deleted and replaced by values of time markers calculated according to the algorithm detecting and correcting the detected synchronization errors, after which the packets with so corrected time stamps are appended appropriately to the output MPEG stream. The essence of the invention is based in that packets of each input MPEG stream are transferred from stream buffers to appropriate packet buffers together with information about the time ratios between the neighboring packets of a given MPEG input stream. After that, input packets of MPEG streams are retrieved from the mentioned packet buffers by means of a multiplexer to the packet converter. In the packet converter there is a check of the time ratios between the neighboring packets of input streams, the state of the clock of a given output stream, the time of sending the last packet from the given packet buffer and the allowed time offset of packets in the output stream and on their basis the time markers, included in them, are corrected according to the value of the clock of MPEG output stream. Next, selected packets are appended adequately to the MPEG output stream.

In another aspect of the present invention, the packets delivered to the stream buffers are filtered according to specific criteria, while these criteria of packets filtering define PID numbers of the delivered packets.

In yet another aspect of the present invention, data are transferred from stream buffers to packet buffers at the request of the output module, after checking that the packet buffer can receive them.

In case of equipping the stream buffer with additional clock, the frequency of the clock adjusts itself to the frequency of the clock of time stamps of the packets of the given stream based on the values of the average, calculated of at least two measurements of the values of time stamps of the packets of the given stream.

In the method according to the invention, in the MPEG stream processing unit, favorably any changes of the quantity of available stream buffers are monitored by means of an independent process and based on these changes packet buffers are added or deleted.

In yet another aspect of the present invention, time ratios between the neighboring packets of a given stream are defined as a difference of time stamps between the current and the previous packet of a given stream.

Moreover, favorably for the first packet of the given input stream the time stamp of the previous packet are defined as equal to the time stamp of the current packet.

It is also favorable that for the first packet sent from the given packet buffer the time of sending the last packet for this buffer is set to the value of the time of the output stream clock.

In yet another aspect of the present invention, for the second and the next packets, of a given packet buffer, time of sending the last packet for this packet buffer is set to the value of the sum of the time of sending the last packet for this packet buffer and time ratios between the neighboring packets of the given output stream.

In yet another aspect of the present invention, the packet of the given packet buffer is appended to the MPEG output stream, when the sum of the time of sending the last packet for the given packet buffer and time ratios of input streams, decreased with the current value of the clock of the output stream is not greater than the allowed time offset of packets in the output stream.

Moreover, additional data, favorably MHP system applications are added to the sent data.

The solution according to the invention can be fully realized by means of software, which provides many advantages. These advantages include among others easier upgrading, greater flexibility, higher precision of clocks, any number of audio-video channels from each transport stream TS.

According to the invention each input stream can have its own clock, which is next synchronized with others.

The method, according to the invention, thanks to the possibility of software implementation of the method of synchronizing the packets broadcasted in MPEG stream, allows an easy way to divide N input MPEG streams into parts, for example by filtering the packets with one PID number, adding time stamps to every packet, and next based on these stamps compiling the target stream, meanwhile removing all errors and time offsets.

Errors can occur because of the high frequency of PCR clocks and unpredictable delays in operation of programs.

Thanks to the presented mechanism of time errors correction, dedicated to software implementation, creating a system for joining MPEG streams is much simpler and cheaper in comparison to hardware solutions.

Moreover, as mentioned above, the software solution means easier upgrading. For example one can add new internal multiplexers or blocks modifying video data, for example decompressing MPEG stream, operations on frames, (for example an exchange of a given program from colorful version to black and white) and next repeated compression.

The solution, according to the invention, implemented as software solution, is also more flexible. For example, one can send data between the input and the output of the system by means of Ethernet network. The additional output clock is calculated with high precision, often more precise than it is allowed by quartz-oscillator used in hardware solutions.

The method, according to the invention, implemented by means of software, allows adding any data to the MPEG stream. The software solution allows also selecting any number of audio/video channels for processing from each input TS transport stream.

Moreover, if files are sources of streams, they can be joined with much higher speed than MPEG streams broadcasted in real time.

It follows that data reading and recording from files can be faster than retrieving data from television signal.

The subsequent advantages of the solution are that decompression and repeated compression of streams, which can be encountered in a few solutions, is avoided and the fact that all the data between inputs and outputs of the system are processed in separated parts of the streams, which considerably decreases the amount of data sent between the internal elements of the system.

According to the invention, the fragmented stream undergoes correction of errors, which have already occurred in the stream and errors, which occurred at joining separate parts of TS stream. According to the invention these errors are corrected by the input module.

According to the described invention there is also synchronization and correction of the precision of PCR clock synchronization with the PTS and DTS time stamps. The above operations can also be performed on ‘partial TS’ streams.

The novel features, which are considered as characteristic for the invention are set forth in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

In the accompanying drawings one of the possible embodiments of the present invention is shown, where:

FIG. 1 is an example of the system joining selected parts of the input streams,

FIG. 2A presents interferences of PCR clocks, which are corrected,

FIG. 2B illustrates interferences of PCR clocks, which are corrected,

FIG. 3A presents an example of joining MPEG streams,

FIG. 3B presents an example of joining MPEG streams,

FIG. 4 presents the output module,

FIG. 5A shows a method of processing data by the output module,

FIG. 5B shows a diagram of control of readiness of the data packet,

FIG. 6 shows a method of joining exemplary data streams.

### DESCRIPTION OF INVENTION AND PREFERRED EMBODIMENT

In the following description, for purposes of explanation rather than limitation, specific details are set forth such as the particular architecture, interfaces, techniques, etc., in order to provide a thorough understanding of the present invention. For purposes of simplicity and clarity, detailed descriptions of well-known devices, circuits, and methods are omitted so as not to obscure the description of the present invention with unnecessary detail.

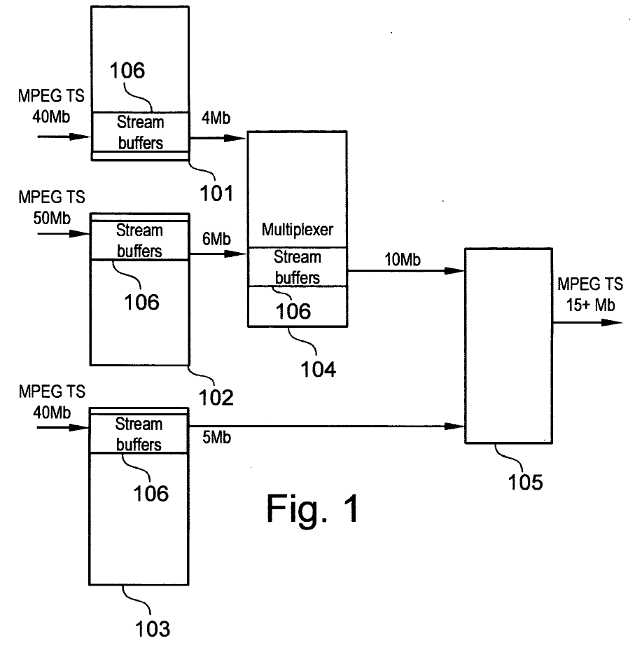

FIG. 1 shows an example of the system, which receives input MPEG TS streams, divides them and reads only selected data, which are next joined into one MPEG TS output stream with appropriately corrected values of stream clocks.

In the example three input MPEG TS streams, with different transmission speeds, are processed. The first and the third stream are transmitted at the speed of 40 megabits per second and the second stream is broadcasted with the speed of 50 megabits per second.

Input modules 101, 102, 103 are responsible for filtering streams according to the parameters set by the user and communication with the output elements of the system, multiplexer 104 and output module 105.

Data from input modules 101, 102, 103 can be transmitted to the output module 105, or to intermediary modules as the multiplexer 104. In the example, the input modules 101 and 102 transmit respectively 4 and 6 megabits of data to the multiplexer 104.

Data from this intermediary module are coupled with data from the input module 103 through output module 105, which creates output MPEG TS stream with transmission speed of 15 megabits per second or higher, if the exemplary output module 105 retrieves data also from other sources, not shown in FIG. 1.

Input modules 101, 102, 103 include additionally data buffers, which allow monitoring packets, which will be processed in the future. These elements were called stream buffers 106.

According to the invention data are retrieved at request of the output module 105. However, it is also possible to execute a system, in which data are sent from input modules 101, 102, 103.

Clocks of input streams are different than the clock set in the input modules 105 (usually in the range defined by MPEG standard).

That is why the input modules 101, 102, 103 send information about a delay of a given packet in reference to the packet sent previously to the recipients together with the data.

Each input module 101, 102, 103 has its own clock, and synchronizes it with the PCR clock of the stream supplied to its input. The received packet waits to be sent in the data queue. If any data wait to be sent, they are sent.

In opposite case, the stream is filled in with stuffing so that the required transmission speed of the data stream can be maintained. The output stream of the system can also be filled with utility data, for example applications of MHP system—Multimedia Home Platform.

This is a very important advantage, because in the known solutions of joining streams there is no possibility of adding any application as the element filling the output stream, when all data of the channels (audio, video, application data) were already sent.

Correct synchronization of the MPEG stream packets is very important, because the standard defining the transmission sets a very low error margin, which for the frequency of PCR clock at 27 MHZ is only 810 Hz.

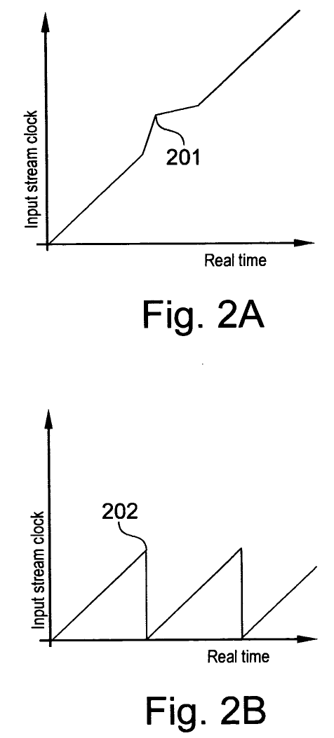

FIG. 2A and FIG. 2B show interferences of PCR clocks, which may occur at transmission of MPEG stream.

The first type of interferences 201, shown in FIG. 2A, illustrates the situation, when the stream packets are lost. This type of errors occurs also when a correct MPEG stream was a subject to modifications, made with insufficient accuracy, yet well enough for the interferences to be negligibly small, imperceptible to a recipient watching television transmission.

Such inaccurate processing of the stream often occurs when a stream needs to be replaced quickly, for the time being regardless small errors.

At that time the PCR clock broadcasted with intervals of, for example, 1000 packets, can behave like in the drawing. This happens in a situation, when due to a loss, or a change of the sequence of packets, the packets with the next PCR value arrives earlier than it would happen in case of receiving a complete number of packets.

The second type of interferences 202 takes place, when the input MPEG stream is read from a file in a loop. At that time the values of PCR clock behave like in FIG. 2B.

The system, according to the invention detects such changes and acts in such a way that they do not impact the output MPEG stream. Data are sent in such a way, that the PCR values grow all the time.

Additional difficulty is that the input streams cannot be joined when packets are sent alternately from each input, because this leads to interruptions or a loss of audio and/or video transmission, possibly to offsets between the image and sound.

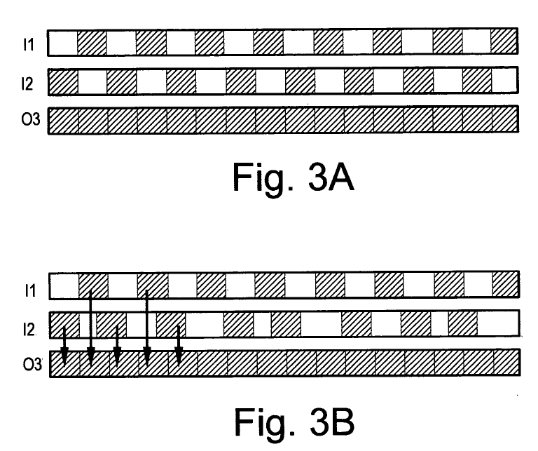

FIG. 3A and FIG. 3B illustrate exemplary joining of two input transport streams I1 and I2 in one output stream 13.

An ideal situation, which does not occur in real conditions, is illustrated in FIG. 3A. In such case there is no necessity of variable correction of PCR value.

In reality, it is never known which PID numbers will be filtered and how many packets there will be with these numbers. Additionally, one should care about the appropriate joining of streams with different data speed.

In real conditions, a situation illustrated in FIG. 3B occurs more frequently, where the packets, separated from input streams come to the output module in the same time. Joining of such streams requires correction of most of the PCR clocks values of the received packets and correct anticipation of times, in which the packets must be sent.

In case of the exemplary transmission, the source module has sent the first packet to the output module. The output module, due to no other possibility (it is engaged in a specific time) sends the received packet at some later time, for example after 20 microseconds.

The next packet sent by the input module is to be sent, for example, 100 microseconds after the previous packet. In order to avoid time shifts in the whole stream, the output module, if it is free, will send the second packet after 80 microseconds or as close as possible to this time. So that it tries, in effect, to reduce the delay, occurring after the first packet is sent.

In the time, when sending the second packet is awaited, data, waiting at other inputs, are sent. Due to such operations, errors, shown in FIG. 2A, occur and additional remedial steps should be taken in order to correct the PCR values.

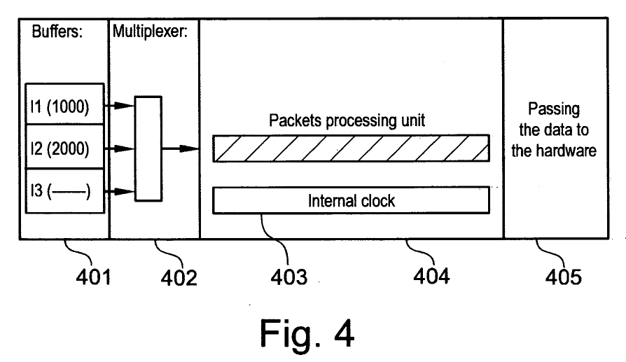

In FIG. 4 the internal components of the output module 105 are presented. This module joins packets into the output data stream. The inputs 401 contain buffers, capable of storing the incoming packets and information about time, in which data are to be sent. These elements are called packet buffers.

In the example, the packet received from input I1 is to be sent after 1000 cycles of the clock have elapsed since the previous packet has been sent from input I1. The packet received from I2 input is to be sent after 2000 cycles of the clock have elapsed since the previous packet from I2 input has been sent. The packet received from I3 input is to be sent, when there are no data waiting to be sent at inputs I1 and I2 or the time of sending them is so remote in the future that in the meantime data from input I3 can be sent.

The internal clock 403 of the input module 105 is used to synchronize data setting in the stream. This clock is generated by means of software or hardware and its frequency is precisely equal 27 MHz.

The internal multiplexer 402 of the output module 105 manages the transmission of packets in a suitable sequence to the packet processing unit 404, in which corrections of PCR, PTS and DTS values are made. In the packet processing unit 404 there is also a full output stream available with packets ordered adequately.

The last task of the output module 106 is to send data to the hardware elements 406, which will send them to receivers.

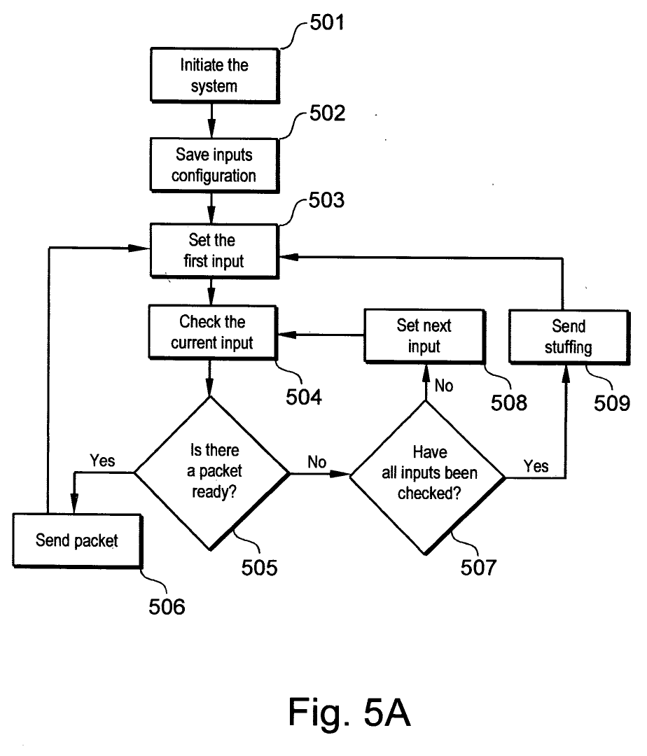

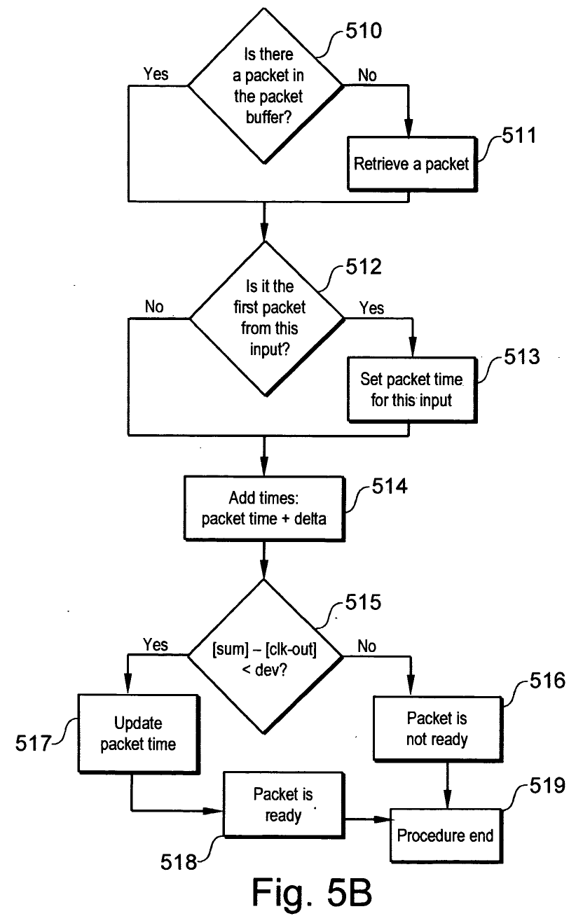

FIG. 5A presents a method in which data are processed in the output module 105, which joins the streams. The procedure starts at point 601 with system initialization. The clocks of input modules 101, 102, 103 and output modules 105 are started and monitoring of data streams starts.

When streams are processed, the input modules monitor the values of PCR time stamps, in order to adjust their clocks to these values and transfer data to the outputs with appropriate speed.

The internal clocks of the input modules 101, 102, 103 are not corrected after each change of the speed of broadcasting the values of PCR time stamps. The clock is corrected, based on the average, calculated in many measurements, so that it is adjusted to the average frequency of changes of PCR time stamps.

It will be evident to a specialist that other methods of adjusting the clock may be used. It is crucial for the mechanism of adjusting the clock to be insensitive to errors of the incoming values of PCR time stamps for the above mentioned reasons (FIG. 2A and FIG. 2B).

In a special situation, when it is certain that the incoming data are transmitted at a good speed, it is not necessary to synchronize the clocks, thus system clocks, associated with the inputs, are not needed, because the time between the packets can be calculated by measuring the time gap between the packets at the input.

Next, in step 502 of the procedure, the configuration of inputs, which are serviced, is stored in the input module 105 together with parameters such as transmission speed of output stream. After completing this task in step 503 the first input is set as a source, from which data will be retrieved in the first sequence.

In the next step 504 the current input is checked and a request to retrieve the next data packet is sent. In the next step 605 it is checked if the packet is ready and if it can be sent. If so, the packet is sent in step 506 in the time consistent with the time markers.

In opposite case, in step 507 it is checked if the data have already been retrieved from all inputs. If the data retrieved from the inputs must wait for the appropriate sending time, the system, while waiting for this time, sends the stuffing data in step 509.

If there is any unchecked input left, it becomes activated and a request of sending the next data packets is sent to it.

The algorithm described above favors the first input (this input is most frequently checked if there are any data available)—also inputs can be changed according to the most advanced algorithm. For example, by considering the amount of data sent from all the inputs. Another possibility is to move from step 506 to step 507, which ensures the even use of all inputs.

The course of step 505, in which the readiness of the packet is checked, is presented in detail in FIG. 5B. The first step 510 is to define, if the packet is already located in the packet buffer of the output module 105. As stated above, packet buffers store data retrieved from input modules 101, 102, 103.

If not, then in step 511 a packet is retrieved from a given input. A value of delta time, which separates the packet from the previous packet, is assigned to it (value 0 in case of the first packet of a given stream).

Next step 512 of the procedure is to check if currently retrieved packet is the first packet from this stream. If it is the first packet, step 613 of the procedure is performed, in which the time of the previous packet for this input is set to the current value of the clock 403 of the output module 105.

In opposite case the procedure comes to step 514 where the times of the previous packet and time delta are added. In the next step 515 it is checked if the difference of the calculated sum and current clock value is lower than the deviation of the time of sending the packet, for example 100 clock cycles.

If so, in the next step 517, time of the last packet is updated according to the earlier calculated sum. Execution of this operation means that the packet is ready. If the check in step 515 is not true, the packet is not ready to be sent.

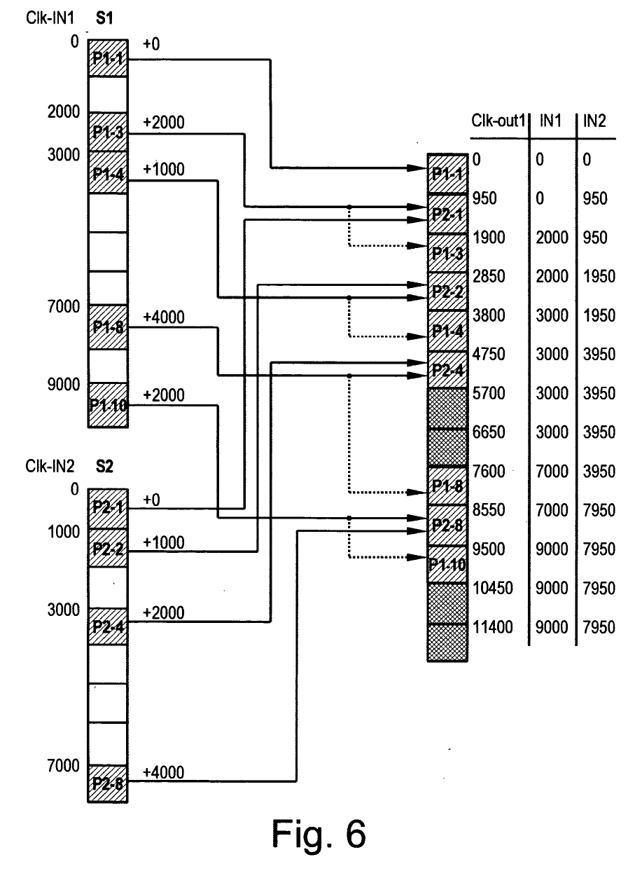

In order to present the method of joining the streams, two exemplary data streams and value of clocks for every packet were shown in FIG. 6.

The packets marked with numbers are to be send to outputs of appropriate input modules. The drawing shows only fragments of streams S1 and S2, from which 5 and 4 data packets are to be sent respectively.

The simulation, presented in the drawing, was conducted assuming that the deviation from the nominal time (the allowed time offset of packets in the output stream), with which the given packet will be sent, is 100 cycles of the clock.

That means that the packet waiting to be sent at the time of 2000 clock cycles can be sent when the clock is between 1900 and 2100 cycle (optimum conditions) or later, if it cannot be sent in a specific, preferred time range. All packets of the output stream that are sent, assume PCR values equal to the state of clock 403 of the output module 105.

The table in FIG. 6 shows, in the sequence from the left side, the current value of PCR clock of output stream Clk-out1, the packet time IN1 for the input stream S1 and packet time IN2 for input stream S2.

Sending data starts when the clocks Clk-IN1, Clk-1N2 and Clk-out1 have value 0. The drawing shows also delta times of the packets and the times of packets of individual inputs, stored in the input buffers 401 of the output module 105 (FIG. 4).

At the start of joining the streams, the output module 105 retrieves the first data packet from the first input. It receives the packet marked P1-1, which is immediately sent, because this is the first packet. In the same time the packet time for input IN1 is set to value 0. After sending P1-1 the output module 105 retrieves the next packet from input 1.

However, delta time for the next packet is 2000. This packet is stored, and output module 105 retrieves a new packet P2-1 from the second source IN2.

The retrieved packet P2-1 is the first from this input, thus it is sent immediately, and the packet time is set to 950, because this is the first packet from this input module.

After sending it, with the clock Clk-out1 state at 1900 possibility of sending packet P1-3 is checked. In view of the possible deviation 100, the packet with the delta time 2000 can be sent in the current moment. Clk-out1 clock has the value of 1900.

After sending packet P1-3 the module sets the time of the packet of this input at 2000 and collects the next packet PI-4. Because 2000+1000 clock cycles for delta time after deducting the current clock Clk-out1 value gives result higher than the allowed deviation, the packet is suspended.

In this moment the output module 105 retrieves the next packet from the second input P2-2. Because delta time for this packet is 1000, and the current time is 2850, and the previous packet from this input was sent in the time 950, the packet will be sent. The value of the packet time for the second input is set at 1950.

Sending the packet lasts until time 3800, when the waiting packet from the first input is checked once again. Because 3000-3800<=100, packet P1-4 is sent, and the packet time for the first input is set at 3000.

In this time a delay occurs for the packet of the first stream, because packet P1-4 was sent at 1900 clock cycles after P1-3, while in ideal situation it should be 1000 cycles.

After sending packet P1-4, the time Clk-out1 is 4750 and the output module 105 retrieves the next packet from the first input. Delta of this packet P1-8 is 4000, and that is why the allowed time of sending it is 6900. Accordingly, this packet will be waiting in the queue and the next packet will be retrieved from the second input. Delta of the packet P24 is 2000.

Because (1950+2000)−4750=−800, packet P2-4 is sent, and the value of the packet time is set at 3950.

The next step, in the cycle of Clkout1 5700 clock, is to retrieve the next packet from the second input, because the packet from the first input must still wait.

The delta time of the received packet P2-8 is 4000, thus it must wait until the value of the Clk-out1 equals at least 7850.

That means that in a given time 5700 no useful data can be sent. That is why a packet of stuffing data will be sent.

This packet is sent by the time 6650. Since useful data cannot be still sent, a next stuffing packet is sent. Sending it finishes at the moment 7600. The above two stuffing packets can also be retrieved from unsynchronized input, for example with MHP applications.

Unsynchronized input is such input from which data are appended to the output stream only when the data from the main inputs we1 and we2 must wait by the appropriate moment of sending. Data from unsynchronized inputs do not require PCR correction.

Checking the waiting packets, the output module 105 finds that packet P1-8 should be sent. Sending this packet is slightly delayed. The packet time of the first input is set at 7000.

After sending the packet the current time of the Clk-out1 clock is 8550. The recently sent packet came from the first input. That is why the input module 105 collects the next packet P1-10 from this input. Delta time for this packet is 2000, and therefore it must wait in the queue, and instead of it P2-8 packet will be sent, which already waits in the buffer of the output module 105.

The result of the action (3950+4000−8550 is lower than the value of the allowed deviation and the packet time for the second input is set at the value of 7950. The packet is sent, when Clk-out1 has the value of 9500.

The last step, which should be performed for the exemplary streams from FIG. 6, is to send packet P1-10 of the output module 105 waiting in the buffer.

The packet is send, because the check of the allowed deviation gives the result of −500, and the packet time for the first input is set at the value of 9000.

Considering that all the data packets were sent, the next packets are stuffing packets. These can also be packets coming from unsynchronized input, for example from MHP application.

The preferred embodiments having been thus described, it will now be evident to those skilled in the art that further variation thereto may be contemplated. Such variations are not to be regarded as a departure from the invention, the true scope of the invention being set forth in the claims appended hereto.

1. A method for multiplexing, in MPEG stream processor, packets of input MPEG streams into one output transport stream with simultaneous correction of time stamps, where input streams of MPEG data are supplied with defined time stamps of their packets and at the same time packets of MPEG input streams are multiplexed and their time stamps are corrected in such a way that their set time stamps are removed and replaced with the values of time stamps calculated according to the algorithm, which detects and corrects the detected synchronization errors and next, packets with so corrected time stamps are appended suitably to the output MPEG stream, characterized in that:
a. packets of every input MPEG stream are transmitted from stream buffers to appropriate packet buffers, together with information about time relations between the neighboring packets of a given input MPEG stream and afterwards,
b. the packets of input MPEG streams are retrieved from the mentioned packet buffers to packet processing unit by means of a multiplexer
i. and in the packet processing unit,
the time relations between the neighboring packets of input streams are checked and
the time relations are also checked for the state of the clock of a given output stream, the time of sending the last packet from a given packet buffer and the allowed time offset of packets in the output stream
and based on them the time stamps contained in them are corrected according to the value of the clock of the output MPEG stream
c. and next appropriately selected packets are appended to the output MPEG stream.

2. The method, according to claim 1, characterized in that the packets supplied to the stream buffers are filtered according to specific criteria.

3. The method, according to claim 2, characterized in that the criteria of filtering packets are specified by the PID numbers of the supplied packets.

4. The method, according to claim 1, characterized in that data are transmitted from stream buffers to packet buffers at the request of the output module.

5. The method, according to claim 1, characterized in that the data from stream buffers are transmitted to the packet buffers after checking that the packet buffer can receive them.

6. The method, according to claim 1, characterized in that in case of equipping the stream buffer with additional clock, the frequency of this clock adjusts to the frequency of the clock of time stamps of packets of a given stream, based on the average value, calculated from at least two measurements of the values of time stamps of packets of a given stream.

7. The method, according to claim 1, characterized in that in the system processing MPEG streams, changes of the quantity of available stream buffers are monitored by means of an independent process and based on these changes packet buffers are added or removed.

8. The method, according to claim 1, characterized in that time relations between the neighboring packets of a given stream are defined as a difference of the time stamps between the current, and the previous packet of a given stream.

9. The method, according to claim 8, characterized in that for the first packet from the given input stream, the time stamp of the previous packet is defined as equal to the-time stamp of the current packet.
